(19) United States
(12) Patent Application Publication
(10) Pub. No.: US 2012/0102406 A1
(43) Pub. Date: Apr. 26, 2012

(54) COMPOSITION MODEL FOR COMPONENTS OF A USER INTERFACE FRAMEWORK FOR WEB APPLICATIONS

(76) Inventors: Hilmar Demant, Karlsdorf (DE); Sebastian Droll, Heidelberg (DE); Joachim Fitzer, Schriesheim (DE); Ioannis Grammatikakis, Maxdorf (DE); Jan Heiler, Walldorf (DE); Juergen Sattler, Wiesloch (DE); Frank Schertel, Mannheim (DE); Markus Viol, Walldorf (DE); Thorsten Weber, Mannheim (DE)

(21) Appl. No.: 12/908,897

(22) Filed: Oct. 21, 2010

(51) Int. Cl. G06F 3/01

(52) U.S. Cl. 715/734

(57) ABSTRACT

Various embodiments of systems and methods for a composition model for components of a user interface framework for Web applications are described. The methods include a loosely coupled method and a tightly coupled method for composing components in a UI framework. The loosely coupled method includes triggering a navigation pipe from an out-port of a first component to an in-port of a second component and defining a context mapping between a first set of parameters of the out-port of the first component and a second set of parameters of the in-port of the second component. The tightly coupled method includes exposing a binding reference from the first component to the second component and specifying a first data model entity from the first component to be bound to a second data model entity of the second component via a binding contract.

### FIELD

The field generally relates to the software arts, and, more specifically, to methods and systems for a composition model for components of a user interface framework for Web applications.

### BACKGROUND

In the world of computing, Web applications such as Rich Internet Applications (RIAs) have many of the characteristics of desktop applications. The RIAs are typically delivered either by a site-specific browser, a browser plug-in, or independently via a virtual machine. The most commonly used frameworks that support such Web applications are Adobe Flash®, Java, and Microsoft Silverlight®. Generally, the framework has to be installed using the computer's operating system prior to launching the RIA. The Web application framework typically downloads, updates, verifies, and executes the RIA. Microsoft Silverlight® is a programmable Web browser plug-in that enables features such as animation, vector graphics and audio-video playback that characterize RIAs. Microsoft Silverlight® brings additional interactivity features and support for .NET® languages and development tools. It is compatible with multiple Web browser products. Microsoft Silverlight®, which was developed under the codename Windows® Presentation Foundation/Everywhere (WPF/E), is a web-based subset of WPF.

Many Web application frameworks follow the Model View Controller (MVC) architectural pattern to separate the data model with the business logic from the user interface. The MVC pattern modularizes code, promotes code reuse (use of existing software code, or software knowledge, to build new software code), and allows multiple interfaces to be applied. The MVC architecture consists of a model, a view, and a controller. The model part of the MVC pattern is a domain-specific representation of the data upon which the application operates. Domain logic adds meaning to raw data (for example, calculating the totals, taxes, and shipping charges for shopping cart items). When a model changes its state, it notifies its associated views so they can refresh. The view of the MVC pattern renders the model into a form suitable for interaction, typically a user interface element. Multiple views can exist for a single model for different purposes. The controller of the MVC pattern receives input and initiates a response by making calls on model objects. When a Web application user interface framework is built on the MVC architectural pattern approach, high speed development of uniform user interfaces (UIs) is possible.

### SUMMARY

Various embodiments of systems and methods for a composition model for components of a user interface framework for Web applications are described herein. In an embodiment, the method includes triggering a coupling method between a first user interface component and a second user interface component in a user interface framework. If the triggered coupling method is a loosely coupled method, the method further includes triggering a navigation pipe from an out-port of the first user interface component to an in-port of the second user interface component. Further, a context mapping is received between a first set of parameters of the out-port of the first user interface component and a second set of parameters of the in-port of the second user interface component. Business data logic is exposed in a declarative way to a data flow between the first user interface component and the second user interface component. Finally, the data flow is sent from the first user interface component to the second user interface component.

In an embodiment, the system includes a database storage unit for storing a plurality of user interface components. The system also includes a user interface runtime framework in communication with the database storage unit. The user interface framework triggers a coupling method between a first user interface component and a second user interface component in a user interface framework. If the triggered coupling method is a loosely coupled method, the user interface framework triggers a navigation pipe from an out-port of the first user interface component to an in-port of the second user interface component. Then, the UI framework receives a context mapping between a first set of parameters of the out-port of the first user interface component and a second set of parameters of the in-port of the second user interface component. Further, the UI framework exposes business data logic in a declarative way to a data flow between the first user interface component and the second user interface component. Finally, the data flow is sent from the first user interface component to the second user interface component.

These and other benefits and features of embodiments of the invention will be apparent upon consideration of the following detailed description of preferred embodiments thereof, presented in connection with the following drawings.

### BRIEF DESCRIPTION OF THE DRAWINGS

The claims set forth the embodiments of the invention with particularity. The invention is illustrated by way of example and not by way of limitation in the figures of the accompanying drawings in which like references indicate similar elements. The embodiments of the invention, together with its advantages, may be best understood from the following detailed description taken in conjunction with the accompanying drawings.

FIG. 1 is a block diagram illustrating an architectural view of a user interface framework as part of an application platform.

FIG. 2 is a block diagram illustrating a generic logical component model.

FIG. 3 is a block diagram illustrating a logical component structure.

FIG. 4 is a block diagram illustrating component composition architecture.

FIG. 5 is a block diagram illustrating mechanisms of embedding of components.

FIG. 6 is a block diagram illustrating component composition context mapping, according to an embodiment.

FIG. 7 is a block diagram illustrating composition and outlook of data flows, according to an embodiment.

FIG. 8 is a flow diagram illustrating a method of composing components in a UI framework, according to an embodiment.

FIG. 9 is a block diagram illustrating an exemplary computer system.

### DETAILED DESCRIPTION

Embodiments of techniques for a composition model for components of a user interface framework for Web applications are described herein. In the following description, numerous specific details are set forth to provide a thorough understanding of embodiments of the invention. One skilled in the relevant art will recognize, however, that the invention can be practiced without one or more of the specific details, or with other methods, components, materials, etc. In other instances, well-known structures, materials, or operations are not shown or described in detail to avoid obscuring aspects of the invention.

Reference throughout this specification to “one embodiment”, “this embodiment” and similar phrases, means that a particular feature, structure, or characteristic described in connection with the embodiment is included in at least one embodiment of the present invention. Thus, the appearances of these phrases in various places throughout this specification are not necessarily all referring to the same embodiment. Furthermore, the particular features, structures, or characteristics may be combined in any suitable manner in one or more embodiment.

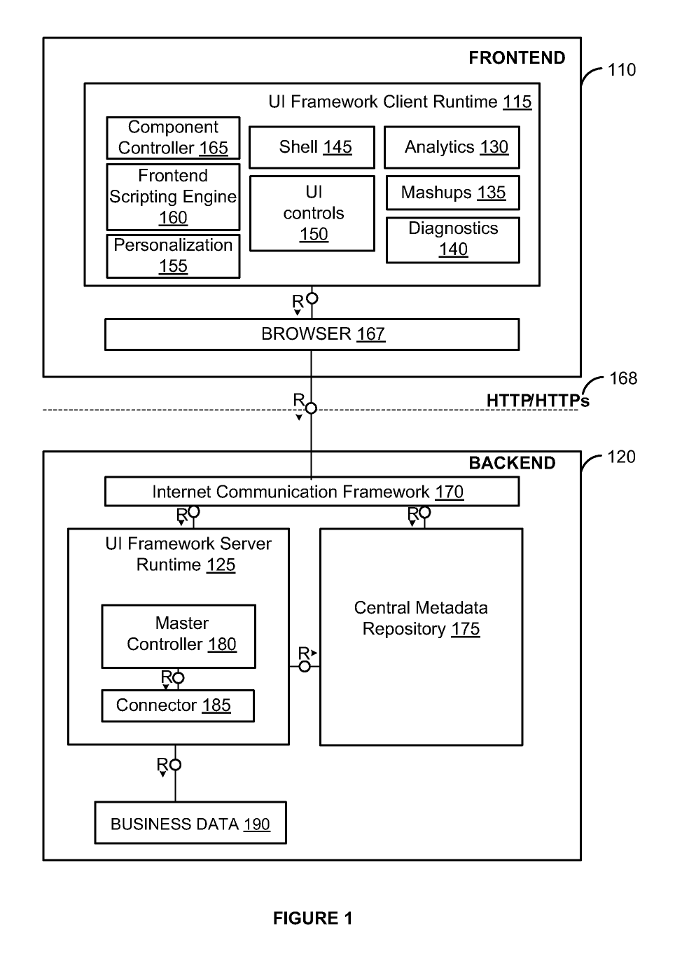

FIG. 1 is a block diagram illustrating an architectural view of a user interface framework as part of an application platform. The application platform is a Web application server including a frontend (client) part 110 and a backend (server) part 120. The UI framework as part of the application platform is responsible for modeling UIs at design time and interpreting them at runtime, so that there is no semantic loss by the generation from one model into another one. The UI framework enables the full separation of UI entities in multiple clients, provides a rendering-engine-independent definition of application UIs and has all the personalization and flexibility features built-in. The UI framework is based on the RIA concept, which removes the need of running Java server in the middle tier for application UI purposes. In this way, the complexity of the UIs is reduced significantly. The UI framework includes a client part—UI Framework Client Runtime 115, and a server part—UI Framework Server Runtime 125.

UI Framework Client Runtime 115 may be implemented in a programming language such as “C™” using a RIA based framework such as Microsoft Silverlight® technology. The UI Framework Client Runtime 115 is responsible for rendering user interfaces and access business data from backend 120. Every user request is triggered on the UI Framework Client Runtime 115. The very first request is a navigation request that results in a request to the backend 120 to read a UI component. The UI component is read from the Central Metadata Repository 175 in the backend 120 and transported to the frontend 110. A component manager instantiates the UI component and a corresponding component controller 165 for the UI component on the frontend 110 and triggers the initialization of the UI component on the backend 120. The component manager builds up a control tree for the UI component out of a set of UI controls 150. These UI controls 150 ensure conformable look and feel and the ability to change UI themes consistently. The controls in the “themed UI controls” package are all enabled in a consistent way for test automation and accessibility, and are provided in a manner so that native implemented custom UI panes can make use of those controls. Usually, more than one UI component is needed to render a UI, as UI components typically embed other UI components (e.g., a Work Center component embeds a set of Work Center View Components and they again embed other components). The top-level UI component that is rendered is the root UI component which makes sure to render a common frame for all UI components, e.g., by rendering the top level navigation and the ability for personalization from personalization unit 155.

In an embodiment, the UI Framework Client Runtime 115 also comprises the following built-in units: analytics 130, mashups 135, diagnostics 140, shell 145, and frontend scripting 160. Analytics 130 are components that represent data in a grouped, aggregated, and hierarchical way. These components serve to answer business questions about, for example, how many products were sold in a particular country and provide drill down capabilities to different level of abstraction. Diagnostics 140 allows the collection of, for example, the context of the current framework and all other running entities of the overall system at a specific point in time (e.g., in case of an exception or error). The collected information can help to track down the cause of the exception. Shell unit 145 provides the shell for running the UI Framework Client Runtime. It includes all units for the user interface ranging from defining the overall appearance of windows (including standard elements such as menus, toolbars, navigation areas, windows management) as well as the mediator layer that maps logical component definitions from the configuration model to physical controls. In addition, there are possibilities to use a Silverlight® feature to run the client in “out of browser” mode. Also, a prototype exists to run the client as a standard WPF desktop client in contrast to the Silverlight® browser plug-in. This requires some replacement of connectivity and authorization code, which is provided by the browser stack itself. Frontend scripting 160 enables data from the client side data model to be read, evaluated, and modified—which causes eventually configured events again in the runtime execution of the model. With these capabilities, UI-only logic can be expressed and modeled via some script; it is not required to implement or model the logic in the backend. Optionally, the script can be executed on the client or backend.

The frontend 110 communicates with the backend 120 via browser 167 on a regular HTTP/HTTPs connection 168 using JavaScript Object Notation (JSON) (also, other serialization formats such as XML can be used in parallel to JSON) as a lightweight data interchange format. The requests from the frontend 110 are received at Internet Communication Framework (ICF) 170. The ICF 170 forwards the requests to the UI Framework Server Runtime 125 and Central Metadata Repository 175. The Central Metadata Repository 175 stores all UI entities with their metadata. The UI Framework Server Runtime 125 reads and interprets the UI model of the application, manages the access to the backend and ensures an optimized communication with the UI Framework Client Runtime 115. After the UI Framework Client Runtime 115 triggers the initialization of a UI component in the backend 120 for a first time in a session, the UI Framework Server Runtime 125 first creates a master controller 180 for the complete session and then creates a component controller for each component that is requested from the UI Framework Client Runtime 115. Each component controller builds a UI data container out of the information of the UI model for a component. At runtime, the composition of the dependent components is combined within the master controller 180, which holds one event queue and performs data updates for all included components as one component. In an embodiment, logically separated declared components can be configured to run as one virtual controller at runtime.

After the master controller 180 has processed all component controllers, it collects all the data that has changed in the UI data container and makes sure that all changed data and only the changed data is transported to the frontend 110. The access from the UI Framework Server Runtime 125 to business data 190 is performed via connector 185. Connector 185 is able to connect to different technologies.

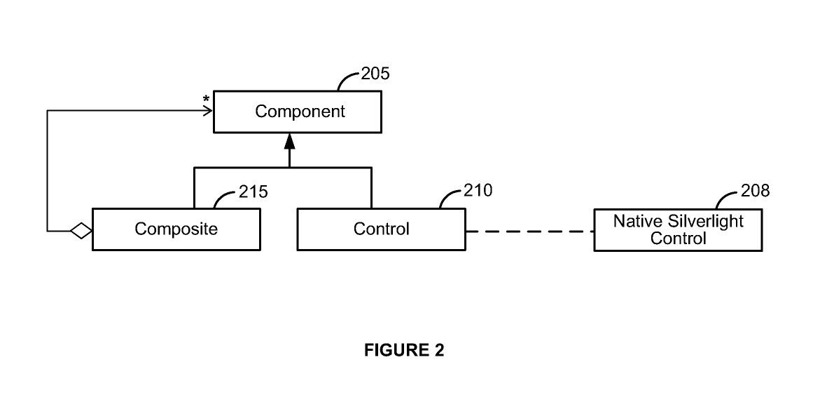

FIG. 2 is a block diagram illustrating a generic logical component model. In the UI framework, a component 205 is a self-contained model of a user interface that can be declaratively used in another UI model. A control can be one of the UI framework provided controls, such as control 210, or a custom implemented control through some software development kit (SDK) or application programming interface (API) for framework controls, which basically becomes a native Silverlight® control 208. In this case, there is an extension mechanism through implementing a framework interface (or deriving from an abstract framework class) to allow plugging in any arbitrary implementation of a native Silverlight® control into the declared components. In the model, some constructs exist that allow plugging in custom panes and custom controls. A control cannot contain other components. A component can also be a composite (Composite Control, Building Block), such as composite 215, which is composed of a set of components (nested composites and/or controls). A composite allows a group of objects to be treated in the same way as a single instance of an object. A composite implements all component methods. The component is the abstraction for all components, including composite ones, and declares an interface for the objects in the composition.

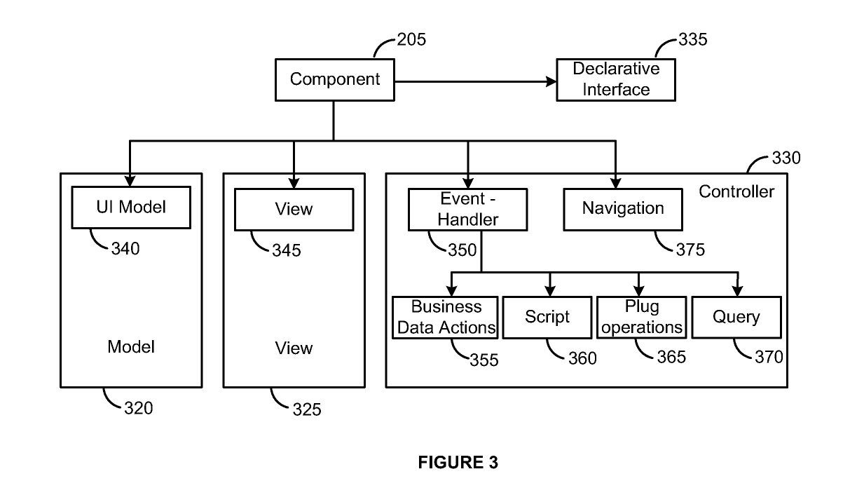

FIG. 3 is a block diagram illustrating a logical component structure. Component 205 consists mainly of a model 320, a View 325, a Controller 330, and a declarative interface 335. View 325 consists of a set of views, such as view 345, which is the description of the user interface that binds to the UI model 340 and triggers event-handlers such as event-handler 350. The UI model 340 describes a data structure, which can bind to backend business data 190. Controller 330 includes different types of event-handlers such as: business data actions 355, script 360, plug operations 365, and query 370. Business data actions 355 include several types of actions defined in the metadata and exposed through the implementation of the business objects. From the UI, an operation of type “BOAction” could be used to trigger a particular action in the context of the current data instance, which again potentially can change the state and data as well. Script 360 is a declaring script logic on the data instances (read, evaluate, modify) with branches, conditions, etc. A plug operation, from plug operations 365, triggers one of the defined out-ports which are used to couple components (embedded or navigation) together. Query 370 in combination with a filter set called “DefaultSets” can be executed from an event handler operation. The defined query of the business object is executed and the query result data is filled into the configured data model list. Navigation 375 is the context mapping for outgoing-incoming operations. The declarative interface 335 exposes ports (in-port and out-port), binding-capabilities for tightly coupled behavior in embedded scenarios, and configuration to the composition environment.

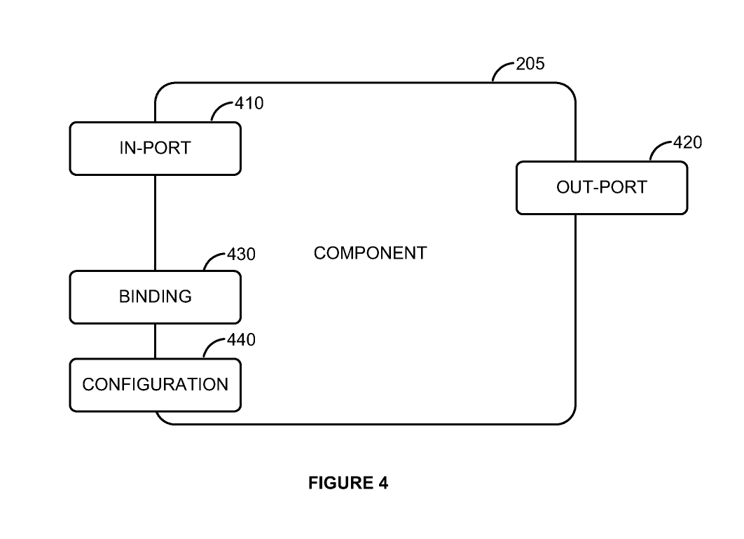

FIG. 4 is a block diagram illustrating component composition architecture. A component (e.g., component 205) can consist of other components, thus forming a composition of components. A leaf component in this composition that does not allow any further branching and does not have any child components attached is referred to as a “control”. There may be different types of controls in a UI framework, e.g., the native Silverlight® control 208. In an embodiment, component 205 consists mainly of a model 320, a View 325, a Controller 330, and a declarative interface 335. The declarative interface 335 of a UI component consists of the following elements: ports such as in-port 410 and out-port 420, binding 430, and configuration 440. The ports 410 and 420 are used to implement a loosely coupled behavior in component embedding or navigation scenarios. The data of a loosely coupled component is loaded asynchronously (an additional roundtrip is needed). The in-ports accept input parameters, which result in implementation of the component in some action processing the input parameters of the in-port. The out-ports can also be used to send out notifications and pass data to other components. Binding 430 is used for tightly coupled behavior in embedding scenarios (synchronous loading)—working directly on the data model of the parent UI model via references to it.

Configuration 440 represents the technical configuration of a component that can be exposed. Whenever a component is used or composed at design time, the user in the given usage scenario can provide a static configuration for the instance of this component usage. The user can also declaratively expose a configuration for a component, for example, to expose configuration that allows support of different styles of visualization (e.g., a configuration designed as a flat field-value list). The configuration is set at design time.

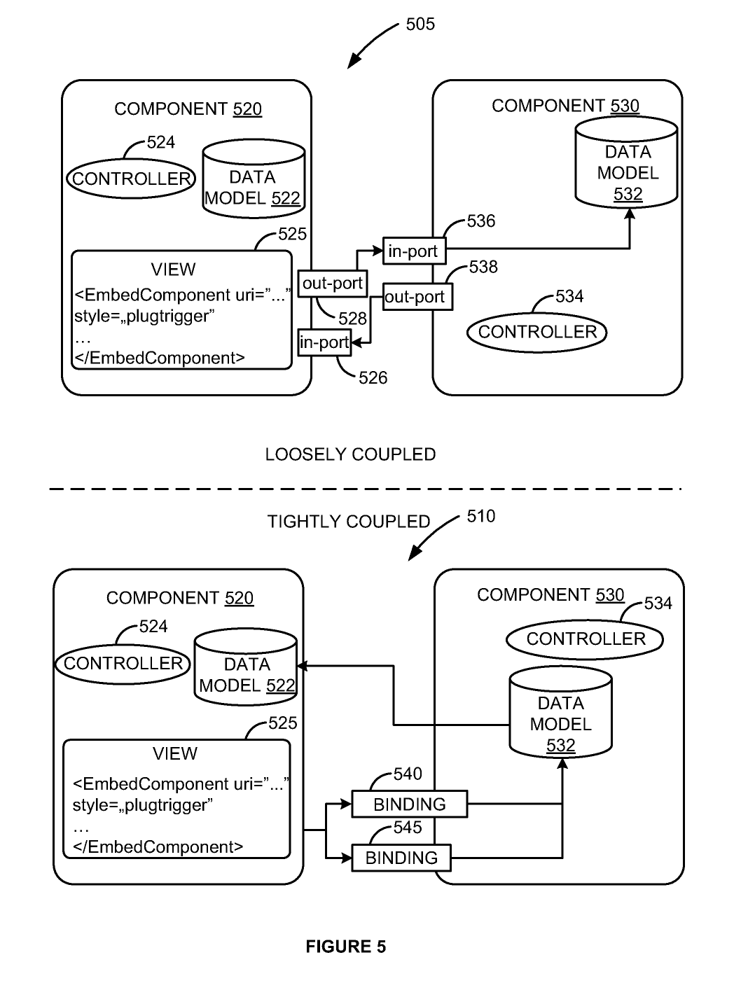

FIG. 5 is a block diagram illustrating mechanisms of embedding of components. In some embodiments, embedded components can be loosely coupled and in other embodiments, the components can be tightly coupled. System 505 presents component 530 loosely coupled to component 520 via the in- and out-port coupling mechanism. Component 520 triggers a navigation from the out-port 528 of component 520 to the in-port 536 of component 530. Components 520 and 530 also contain controllers 524 and 534 according to the MVC model. View 525 is also part of component 520 according to the MVC model. Embedding component 530 is triggered via an in-port context mapping, such as passing of data context from component 520 to component 530. After triggering, component 530 stores and processes the data context. Each component 520 and 530 contains own data model, 522 and 532 correspondingly. All instances of a data model are stored in a data container. The user can choose which values of data model 522 of component 520 they wish to pass to the data model 532 of component 530. These values are then transported to the in-port 536 of the component 530. In-ports (e.g., 526, 536) and out-ports (e.g., 528, 538) can reference a port type definition. The port type definition describes the attributes that are part of the in- and out-ports. The port type enables context-aware information snippet or other components for the end-user composition design time aspect. The available components are determined by all port types provided by the out-ports of the parent component and respective components which implement the corresponding in-port port type. This way of coupling components is best suited for the following scenarios: reporting tools, information snippets “Display Only” for factsheets, providing aggregated overview and decision-relevant information, sales orders, etc. The loosely coupled components are self-contained and responsible for own data binding and controller logic.

System 510 presents component 530 tightly coupled to component 520 via bindings. A user can expose bindings (such as binding 540 and 545), which are references to the internal data model of the component. In an embodiment, there are different type of bindings such as: a field binding that connects two fields with each other; a structure binding that connects a group of elements of the data model to another group of elements in a parent-child component coupling; and a node-reference binding where the parent component specifies to the child component the entry point of the parent component, then the child component can start from this entry point and can subsequently bind data that may not be available in the parent component. For example, if a binding is exposed from component 520 and the user wants to couple component 530 with component 520, a binding contract is defined for the UI framework specifying which data model entity of data model 532 of component 530 to be bound to which data model entity of data model 522 of component 520. As the binding works as a direct reference, whenever some data is changed in the data model 532 at runtime, it is immediately updated in the bound data model 522 as well. The context of a tightly coupled component is bound declaratively to the data context of the embedding component. Data access is handled via references to the parent data model. Component 530 is directly participating in the binding mechanism of the root component 520. Component 530 gets notified about changes in component 520 and triggers notifications.

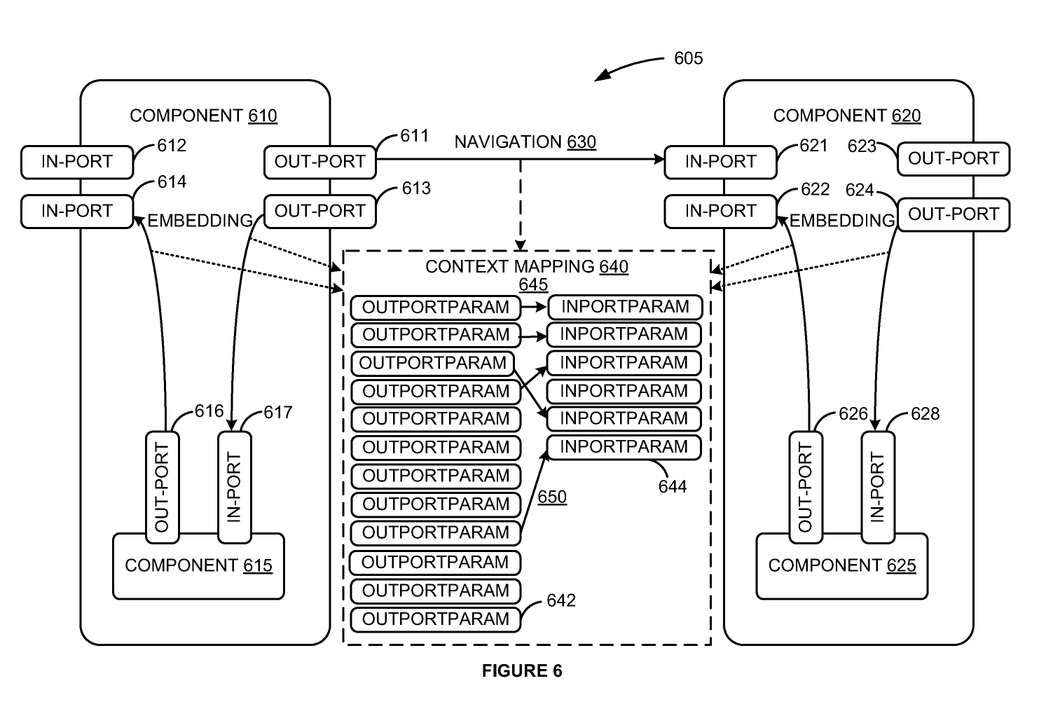

FIG. 6 is a block diagram illustrating component composition context mapping, according to an embodiment. System 605 shows four components: component 610, component 615 embedded in component 605 and running as a child component of component 610, component 620 running individually from component 610, and component 625 embedded in component 620. Since component 620 runs individually from component 610, if component 620 is stopped, component 610 will be still running. But if component 610 is stopped, component 615 will be stopped as well. Component 610 communicates with the embedded component 615 via out-ports 613 and 616 and in-ports 614 and 617. Also, component 610 communicates with component 620 via out-port 611 and in-port 621. There may be additional in-ports (such as in-port 612) and additional out-ports (such as out-port 623) that can be used for communication with other components. Further, component 620 communicates with embedded component 625 via in-ports 622 and 628 and out-ports 624 and 626. In an embodiment, pipes between out-ports and in-ports are used to define navigations between the components, such as navigation 630, including navigations to embedded components. For each out-port-in-port pipe, a context mapping 640 is defined. The context mapping 640 represents a mapping between the out-port parameters of a component (e.g., component 610) and the in-port parameters of another component (e.g., component 620).

As discussed, in-ports and out-ports reference a port type definition. The port type definition describes the attributes that are part of the in- and out-ports. If the out-port parameters (such as outportparam 642) of the parent component reference the same port type definition as the in-port parameters (such as inportparam 644) of the child component, then the context mapping is implicitly performed, as the structure of both out-port and in-port parameters is the same. For example, if the component out-ports of a specific type are declared, this means that some of all types supported by the out-port of the component are known, the framework can detect from the repository and dynamically select all components that support the same type of out-port of the running component. Thus, a selection of components is obtained that fits to the out-port types supported in the running component. The user can then choose what additional components are needed for the given scenario from the obtained selection and embed them in the running component. In an embodiment, these additional fitting components, which are detected via the port type, could be exposed to the user in a view, where the user can select a component and add it to the UI screen composition and store this selection as user personalization.

Referring back to FIG. 6, context mapping 640 shows mapping of parameters with the same type (e.g., mapping 645), when the type of the out-port parameters and the in-port parameters is the same, and mapping of parameters that are of different type (e.g., mapping 650). When the parameters of the out-port of the running component are of different type than the parameters of the in-port of the component to be embedded, then an explicit configuration data has to be provided specifying a list of parameters of the out-port that should map parameters of the in-port. Then at runtime, when the navigation to the component to be embedded is triggered, the data of the out-port parameters will be available and processed (e.g., mapped) for the corresponding in-port parameters. If the out-ports and the in-ports are defined of the same type, then the context mapping is implicit and no additional configuration data is needed.

The navigation between the out-port and the in-port includes the context mapping 640 and the port types to define based on some of the out-port types of the running component which additional components can fit in the running component. These additional components can be dynamically retrieved from the repository. In an embodiment, not only components that are not stored in the system repository can be retrieved but also components that are stored on another machine or accessed via the Internet and have been made available for composing. For example, retrieving components via Web services.

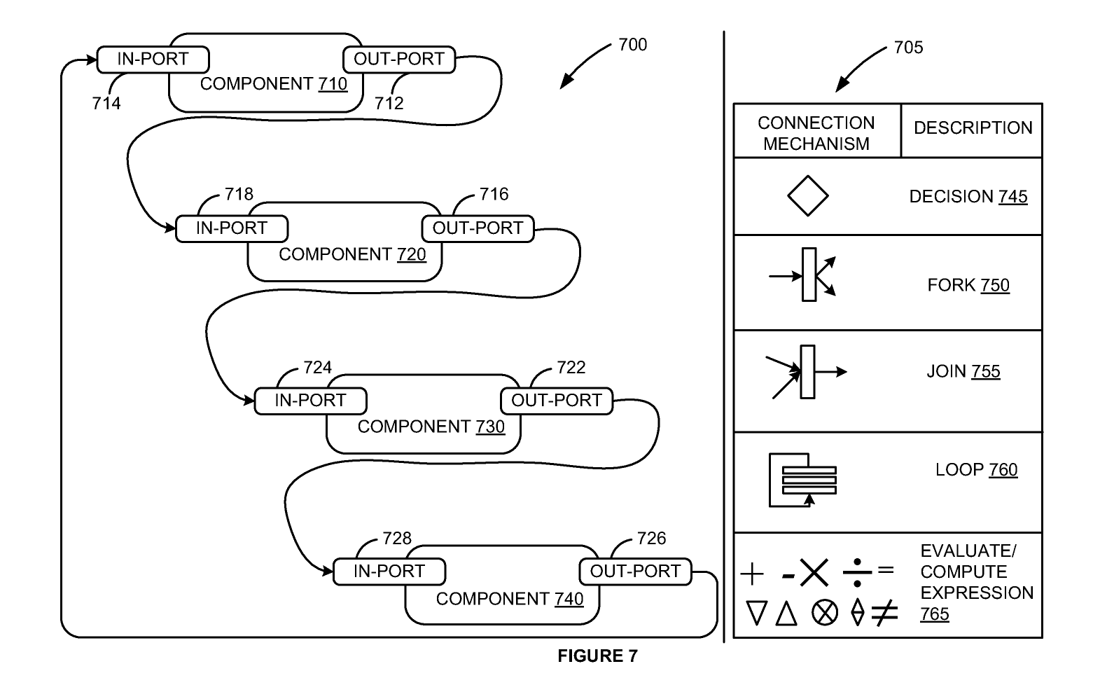

FIG. 7 is a block diagram illustrating composition and outlook of data flows, according to an embodiment. Process 700 shows a simple data flow and context mapping supported in a pipe between components. Process 700 includes a plurality of components (e.g., components 710, 720, 730, and 740) communicating and influencing with each other via in-ports (such as 714, 718, 724, and 728) and out-ports (such as 712, 716, 722, and 726). In an embodiment, each component triggers the next component via some events such as sending/retrieving data in data flows, notifications, and so on. For example, component 710 triggers component 720, which triggers component 730, which triggers component 740, which in turn triggers component 710. After a data flow is set, the business logic of the data is coded (such as a script) in the implementation of the out-ports and in-ports. In an embodiment, this type of internal scripting logic for the data flows has to be dispatched between the components based on conditions of the in-port of one of the components and it may require different out-ports in different cases. In an embodiment, if the components are composed together, additional internal scripting logic can be put in a declarative way on the data flow itself (on a declarative layer of the data), meaning to define decisions for the interacting of the components depending on the incoming calls and outgoing communication such as providing more in-ports or out-ports depending on the scenario, joining calls in one call, and so on. Thus, the internal UI logic that is used to implement a given scenario is extracted and brought on navigation level. For example, component 710 may trigger not one, but two components—720 and 730.

Outlook 705 shows different types of out-ports and in-ports that can be implemented for the composition of the components via declarative (visual) logic such as the commonly known connection mechanisms: decision 745, fork 750, join 755, loop 760, functions 765 that compute or evaluate an expression, etc. It should be noted that components 710, 720, 730, and 740 can be individually running components, embedded components, or a combination of the two.

In an embodiment, the coupling of two components may not be explicitly set, i.e., to define the navigation from one component to the other on 1-to-1 base. This type of communication could involve a component, notification sent from the component in the UI framework, and a subscription module, where other components can be registered with an in-port and listening for notifications/events sent from the first component. When the notification is received in the UI framework, the registered components are invoked and can consume the data that was notified. Therefore, it may not be defined one component to directly communicate with another component, but instead a logical global event is raised by the first component using the out-port units and without coupling to an explicit second component available.

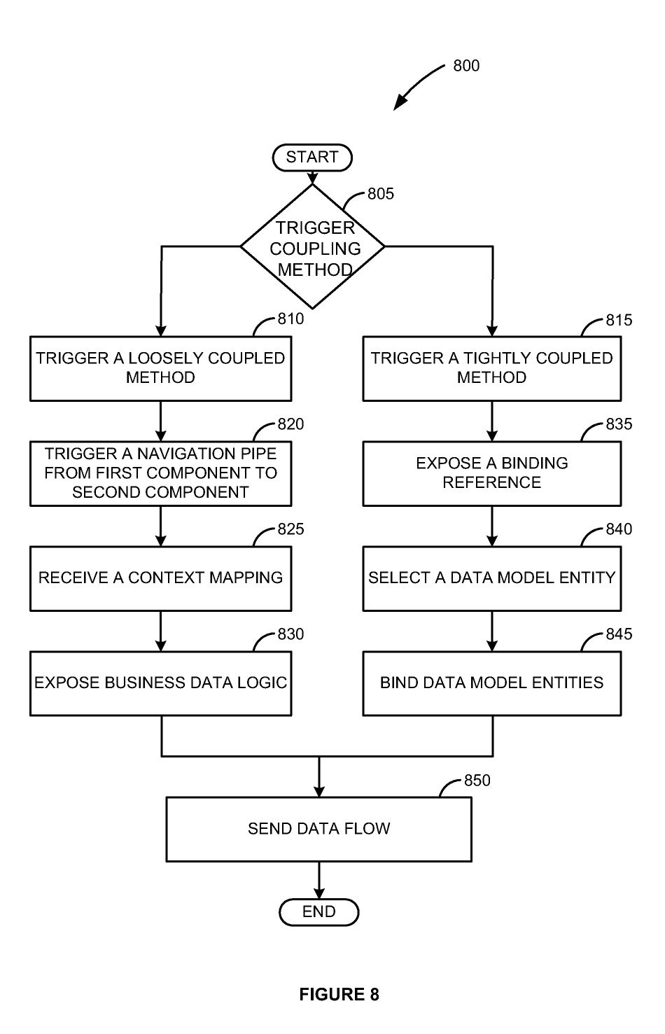

FIG. 8 is a flow diagram illustrating composing components in a UI framework, according to an embodiment. Depending on the usage scenario, at decision block 805, a coupling method is triggered. Process 800 follows the steps either of the loosely coupled method or the tightly coupled method for coupling two components. At block 810, the loosely coupled method is triggered. At block 815, the tightly coupled method is triggered. The two methods can be performed synchronously or asynchronously on a set of components. For example, component A can be loosely coupled to component B, component B can be loosely coupled or tightly coupled to component C, and component D can be loosely or tightly coupled to component A. In the tightly coupled method, the context of the data model of a component is directly bound to the context of the data model of another component, so that the entities of the first data model reference the entities of the second component and are updated immediately upon changes. In the loosely coupled method, the communication between the data models is performed through in-ports and out-ports and context mapping. If the loosely coupled method is triggered, the process continues at block 810. At block 820, a navigation pipe is triggered between the out-port of a first component and the in-port of a second component.

At block 825, a context mapping is defined between a set of parameters of the out-port of the first component and a set of parameters of the in-port of the second component and received at the framework. In an embodiment, all or some of the out-port parameters and all or some of the in-port parameters may be of the same port type. In that case, the mapping of these parameters that have the same port type is direct (or implicit). In other embodiments, all or some of the out-port parameters and all or some of the in-port parameters may be of a different port type. In that case, the mapping of these parameters is indirect (or explicit). The parameters are mapped according to a predefined configuration data list set at design time. At block 830, business data logic is exposed in a declarative way on the data flow at navigation level. In an embodiment, the declarative way includes, but is not limited to, connecting the components via forks, joins, loops, and other visual techniques.

If the tightly coupled mechanism is triggered between the first component and the second component, the process continues at block 815. At block 835, a binding reference is exposed from the first component to the data model of the second component. At block 840, entities from the data model of the second component are selected to be bound to entities of the data model of the first component. At block 845, the selected entities are bound to each other. At block 850, the data flow is sent from the first component to the second component. The data flow may include instructions for sending data, reading data, updating data, executing data, and so on.

Some embodiments of the invention may include the above-described methods being written as one or more software components. These components, and the functionality associated with each, may be used by client, server, distributed, or peer computer systems. These components may be written in a computer language corresponding to one or more programming languages such as, functional, declarative, procedural, object-oriented, lower level languages and the like. They may be linked to other components via various application programming interfaces and then compiled into one complete application for a server or a client. Alternatively, the components may be implemented in server and client applications. Further, these components may be linked together via various distributed programming protocols. Some example embodiments of the invention may include remote procedure calls being used to implement one or more of these components across a distributed programming environment. For example, a logic level may reside on a first computer system that is remotely located from a second computer system containing an interface level (e.g., a graphical user interface). These first and second computer systems can be configured in a server-client, peer-to-peer, or some other configuration. The clients can vary in complexity from mobile and handheld devices, to thin clients and on to thick clients or even other servers.

The above-illustrated software components are tangibly stored on a computer readable storage medium as instructions. The term “computer readable storage medium” should be taken to include a single medium or multiple media that stores one or more sets of instructions. The term “computer readable storage medium” should be taken to include any physical article that is capable of undergoing a set of physical changes to physically store, encode, or otherwise carry a set of instructions for execution by a computer system which causes the computer system to perform any of the methods or process steps described, represented, or illustrated herein. Examples of computer readable storage media include, but are not limited to: magnetic media, such as hard disks, floppy disks, and magnetic tape; optical media such as CD-ROMs, DVDs and holographic devices; magneto-optical media; and hardware devices that are specially configured to store and execute, such as application-specific integrated circuits (“ASICs”), programmable logic devices (“PLDs”) and ROM and RAM devices. Examples of computer readable instructions include machine code, such as produced by a compiler, and files containing higher-level code that are executed by a computer using an interpreter. For example, an embodiment of the invention may be implemented using Java, C++, or other object-oriented programming language and development tools. Another embodiment of the invention may be implemented in hard-wired circuitry in place of, or in combination with machine readable software instructions.

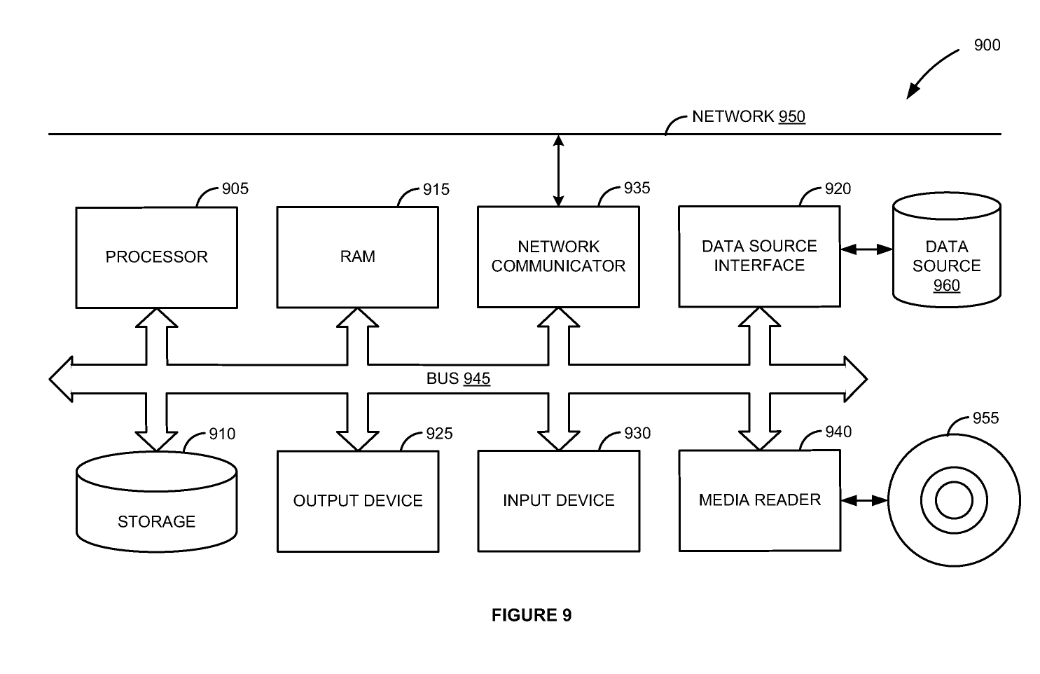

FIG. 9 is a block diagram illustrating an exemplary computer system 900. The computer system 900 includes a processor 905 that executes software instructions or code stored on a computer readable storage medium 955 to perform the above-illustrated methods of the invention. The computer system 900 includes a media reader 940 to read the instructions from the computer readable storage medium 955 and store the instructions in storage 910 or in random access memory (RAM) 915. The storage 910 provides a large space for keeping static data where at least some instructions could be stored for later execution. The stored instructions may be further compiled to generate other representations of the instructions and dynamically stored in the RAM 915. The processor 905 reads instructions from the RAM 915 and performs actions as instructed. According to one embodiment of the invention, the computer system 900 further includes an output device 925 (e.g., a display) to provide at least some of the results of the execution as output including, but not limited to, visual information to users and an input device 930 to provide a user or another device with means for entering data and/or otherwise interact with the computer system 900. Each of these output 925 and input devices 930 could be joined by one or more additional peripherals to further expand the capabilities of the computer system 900. A network communicator 935 may be provided to connect the computer system 900 to a network 950 and in turn to other devices connected to the network 950 including other clients, servers, data stores, and interfaces, for instance. The modules of the computer system 900 are interconnected via a bus 945. Computer system 900 includes a data source interface 920 to access data source 960. The data source 960 can be access via one or more abstraction layers implemented in hardware or software. For example, the data source 960 may be access by network 950. In some embodiments the data source 960 may be accessed via an abstraction layer, such as, a semantic layer.

A data source 960 is an information resource. Data sources include sources of data that enable data storage and retrieval. Data sources may include databases, such as, relational, transactional, hierarchical, multi-dimensional (e.g., OLAP), object oriented databases, and the like. Further data sources include tabular data (e.g., spreadsheets, delimited text files), data tagged with a markup language (e.g., XML data), transactional data, unstructured data (e.g., text files, screen scrapings), hierarchical data (e.g., data in a file system, XML data), files, a plurality of reports, and any other data source accessible through an established protocol, such as, Open DataBase Connectivity (ODBC), produced by an underlying software system (e.g., ERP system), and the like. Data sources may also include a data source where the data is not tangibly stored or otherwise ephemeral such as data streams, broadcast data, and the like. These data sources can include associated data foundations, semantic layers, management systems, security systems and so on.

In the above description, numerous specific details are set forth to provide a thorough understanding of embodiments of the invention. One skilled in the relevant art will recognize, however that the invention can be practiced without one or more of the specific details or with other methods, components, techniques, etc. In other instances, well-known operations or structures are not shown or described in details to avoid obscuring aspects of the invention.

Although the processes illustrated and described herein include series of steps, it will be appreciated that the different embodiments of the present invention are not limited by the illustrated ordering of steps, as some steps may occur in different orders, some concurrently with other steps apart from that shown and described herein. In addition, not all illustrated steps may be required to implement a methodology in accordance with the present invention. Moreover, it will be appreciated that the processes may be implemented in association with the apparatus and systems illustrated and described herein as well as in association with other systems not illustrated.

The above descriptions and illustrations of embodiments of the invention, including what is described in the Abstract, is not intended to be exhaustive or to limit the invention to the precise forms disclosed. While specific embodiments of, and examples for, the invention are described herein for illustrative purposes, various equivalent modifications are possible within the scope of the invention, as those skilled in the relevant art will recognize. These modifications can be made to the invention in light of the above detailed description. Rather, the scope of the invention is to be determined by the following claims, which are to be interpreted in accordance with established doctrines of claim construction.

What is claimed is:

1. An article of manufacture including a computer readable storage medium to tangibly store instructions, which when executed by a computer, cause the computer to:
trigger a coupling method between a first user interface component and a second user interface component;
if the triggered coupling method is a loosely coupled method:
trigger a navigation from an out-port of the first user interface component to an in-port of the second user interface component;
receive a context mapping between a first set of parameters of the out-port of the first user interface component and a second set of parameters of the in-port of the second user interface component;
expose a business data logic in a declarative way to a data flow between the first user interface component and the second user interface component; and
send the data flow from the first user interface component to the second user interface component.

2. The article of manufacture of claim 1, wherein the instructions further cause the computer to:
if the triggered coupling method is a tightly coupled method:
expose a binding reference from the first user interface component to the second user interface component; and
select a first data model entity from the first user interface component to be bound to a second data model entity of the second user interface component via a binding contract.

3. The article of manufacture of claim 1, wherein the instructions further cause the computer to:
receive a global event notification from the first user interface component;
determine a plurality of user interface components registered to a subscription module, wherein the plurality of user interface components are listening for notifications from the first user interface component; and
invoke the plurality of registered user interface components to execute the data flow.

4. The article of manufacture of claim 3, wherein the plurality of user interface components are registered to the subscription module via in-ports.

5. The article of manufacture of claim 1, wherein the in-port and the out-port reference a port type definition that describes a plurality of parameters.

6. The article of manufacture of claim 5, wherein receiving the context mapping between the first set of parameters and the second set of parameters comprises:
if the out-port of the first user interface component and the in-port of the second user interface component reference the same port type definition, map the first set of parameters to the second set of parameters directly; and
if the out-port of the first user interface component and the in-port of the second user interface component reference a different port type definition, map the first set of parameters to the second set of parameters based on an additional predefined configuration data list.

7. The article of manufacture of claim 5, wherein the instructions further cause the computer to:
dynamically retrieve a set of user interface components which in-port parameters match the first set of parameters of the out-port of the first user interface component based on the port type definition.

8. A computerized method comprising:
triggering a coupling method between a first user interface component and a second user interface component in a user interface framework;
if the triggered coupling method is a loosely coupled method:
triggering a navigation pipe from an out-port of the first user interface component to an in-port of the second user interface component;
receiving a context mapping between a first set of parameters of the out-port of the first user interface component and a second set of parameters of the in-port of the second user interface component;
exposing a business data logic in a declarative way to a data flow between the first user interface component and the second user interface component; and
sending the data flow from the first user interface component to the second user interface component.

9. The method of claim 8, further comprising:
if the triggered coupling method is a tightly coupled method:
exposing a binding reference from the first user interface component to the second user interface component; and
specifying a first data model entity from the first user interface component to be bound to a second data model entity of the second user interface component via a binding contract.

10. The method of claim 8, further comprising:
receiving a global event notification from the first user interface component;
determining a plurality of user interface components registered to a subscription module, wherein the plurality of user interface components are listening for notifications from the first user interface component; and
invoking the plurality of registered user interface components to execute the data flow.

11. The method of claim 10, wherein the plurality of user interface components are registered to the subscription module via in-ports.

12. The method of claim 8, wherein the in-port and the out-port reference a port type definition that describes a plurality of parameters.

13. The method of claim 12, wherein receiving the context mapping comprises:
if the out-port of the first user interface component and the in-port of the second user interface component reference the same port type definition, mapping directly the first set of parameters to the second set of parameters; and
if the out-port of the first user interface component and the in-port of the second user interface component reference a different port type definition, mapping the first set of parameters to the second set of parameters based on an additional configuration data.

14. The method of claim 12, further comprising:
dynamically retrieving a set of user interface components which in-port parameters match the first set of parameters of the out-port of the first user interface component based on the port type definition.

15. A computing system comprising:
a database storage unit for storing a plurality of user interface components;
a user interface runtime framework in communication with the database storage unit, the user interface runtime framework to:
trigger a coupling method between a first user interface component and a second user interface component in a user interface framework;
if the triggered coupling method is a loosely coupled method:
trigger a navigation pipe from an out-port of the first user interface component to an in-port of the second user interface component;
receive a context mapping between a first set of parameters of the out-port of the first user interface component and a second set of parameters of the in-port of the second user interface component;
expose a business data logic in a declarative way to a data flow between the first user interface component and the second user interface component; and
send the data flow from the first user interface component to the second user interface component.

16. The computing system of claim 15, further comprising:
a subscription module that listens for events from the first user interface component; and
a subset of user interface components from the plurality of user interface components registered to the subscription module waiting to be invoked upon an event.

17. The computing system of claim 16, wherein the subset of user interface components are registered to the subscription module via in-ports.

18. The computing system of claim 15, wherein the in-port and the out-port reference a port type definition that describes a plurality of parameters.

19. The computing system of claim 15, wherein if the triggered coupling method is a tightly coupled method:
expose a binding reference from the first user interface component to the second user interface component; and
specify a first data model entity from the first user interface component to be bound to a second data model entity of the second user interface component via a binding contract.

20. The computing system of claim 18, wherein the user interface runtime framework dynamically retrieves a set of user interface components from the plurality of user interface components which in-port parameters match the first set of parameters of the out-port of the first user interface component based on the port type definition.
